(19) United States
(12) Patent Application Publication
(10) Pub. No.: US 2007/0108859 A1
(43) Pub. Date: May 17, 2007

(54) Seat motors assembly

(76) Inventors: John Stack, Shelby Township, MI (US); Pawel Sleboda, Bloomfield Hills, MI (US); Valerie Jennings, Warren, MI (US); Chadi Shaya, Sterling Heights, MI (US); Brian Scigiel, Southgate, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/280,832

(22) Filed: Nov. 16, 2005

(51) Int. Cl. B60N 2/02; H02K 47/00; F16M 13/00

(52) U.S. Cl. 310/112; 296/65.16; 248/429

(57) ABSTRACT

The present invention contemplates to power adjustable seats in vehicles that include a seat motors assembly having snap together features to secure one or more metal motor housings between housing end caps. The snap together features have portions that elastically deform and snap back into position to secure the assembly together, while allowing for easy disassembly for servicing.

### BACKGROUND OF INVENTION

The present invention relates to power adjustable seats in vehicles, and in particular to assemblies for seat motors in power adjustable seats.

Power adjustable seat systems for vehicles enjoy wide use today, with many including three separate motors to accomplish multiple seat adjustment functions. Some seat systems have motors that are spaced apart and oriented at different angles, while others include motors mounted side-by-side, parallel to each other. For either of these types of arrangements, the motors are typically each mounted in a relatively thick metal housing in order to meet electromagnetic interference requirements.

An example of a power seat system with parallel motors is described and shown in U.S. Pat. No. 6,857,612, incorporated herein by reference. In this patent, a seat drive mechanism is described that includes three parallel side-by-side bi-directional motors, each mounted in a separate metal motor housing. Each motor housing includes multiple metal tabs extending from its ends. During assembly of the power seat assembly, the motors are mounted in the housings. The housings and end caps are mounted in a jig, and a machine then bends the metal tabs down over features in motor end caps—permanently deforming the tabs to hold the assembly together. In order to remove an end cap for servicing, then, one must find a way to grip and hold the metal tabs with sufficient force to bend the tabs back to their original positions. This type of mounting and securing system has several drawbacks, however. For example, the need for the jig and machine to bend the tabs during initial assembly is more costly and time consuming than is desired. Also, the relative difficulty involved with disassembly is undesirable. In addition, mounting each motor in its own separate housing may be undesirable for certain power seat assemblies.

### SUMMARY OF INVENTION

An embodiment of the present invention contemplates a seat motors assembly for use in a seat drive mechanism of a vehicle. The seat motors assembly may include a first motor housing having a first end with a first snap-in tab extending therefrom, and a second motor housing having a first end with a first snap-in tab extending therefrom. It may also include a first housing end cap including a first motor housing mounting wall operatively engaging the first end of the first motor housing and a first snap retention feature engaging with the first snap-in tab of the first motor housing to releasably secure the first motor housing to the first housing end cap, with the first housing end cap including a second motor housing mounting wall operatively engaging the first end of the second motor housing and a second snap retention feature engaging with the first snap-in tab of the second motor housing to releasably secure the second motor housing to the first housing end cap.

An embodiment of the present invention also contemplates a seat motors assembly for use in a seat drive mechanism of a vehicle. The seat motors assembly may include a motor housing having a first motor portion and a second motor portion, and a first end and an opposed second end; a first housing end cap mounted to the first end of the motor housing; and a second housing end cap mounted to the second end of the motor housing. It may also have a first snap retention feature included in one of the first housing end cap and the second housing end cap, and a first snap-in tab extending from the other of the first housing end cap and the second housing end cap and operatively engaging the first snap retention feature to releasably secure the first housing end cap to the second housing end cap.

An embodiment of the present invention also contemplates a seat motors assembly for use in a seat drive mechanism of a vehicle. The seat motors assembly may include a motor housing having a first end and an opposed second end, a first housing end cap mounted to the first end of the motor housing, and a second housing end cap mounted to the second end of the motor housing. It may also include a first snap retention feature on one of the first housing end cap and the motor housing, and a first snap-in tab on the other of the first housing end cap and the motor housing and operatively engaging the first snap retention feature to releasably secure the first housing end cap to the motor housing.

An advantage of an embodiment of the present invention is that the seat motors assembly can snap together and stay secured—without the need for jigs, additional tools or fasteners, machines for bending metal tabs or other secondary operations—during the assembly process. This may result in an overall cost savings for the seat motors assembly.

A further advantage of an embodiment of the present invention is that the seat motors assembly can be relatively easily disassembled for servicing. The motors can be removed by simple release of the snap-in tabs from snap retention features. Moreover, printed circuit boards that may be mounted in the assembly may be easily accessible through a quick release of a protective PCB assembly cover.

### BRIEF DESCRIPTION OF DRAWINGS

FIG. 1 is a perspective view of a seat motors assembly, in accordance with a first embodiment of the present invention.

FIG. 2 is an exploded perspective view of the seat motors assembly of FIG. 1.

FIG. 3 is a perspective view of the first housing end cap of FIG. 1.

FIG. 4 is a perspective view of the second housing end cap of FIG. 1.

FIG. 5 is a sectional view of a top snap retention feature engaging a snap-in tab in accordance with the first embodiment of the invention.

FIG. 6 is a perspective view of a portion of a first housing end cap and a motor housing in accordance with a second embodiment of the present invention.

FIG. 7 is a perspective view of a portion of the motor housing shown in FIG. 6.

FIG. 8 is a perspective view of a portion of the first housing end cap shown in FIG. 6.

FIG. 9 is a perspective view of a seat motors assembly, in accordance with a third embodiment of the present invention.

FIG. 10 is an exploded perspective view of the seat motors assembly of FIG. 9.

FIG. 11 is a perspective view of a first housing end cap and an integral motor housing in accordance with the third embodiment of the present invention.

### DETAILED DESCRIPTION

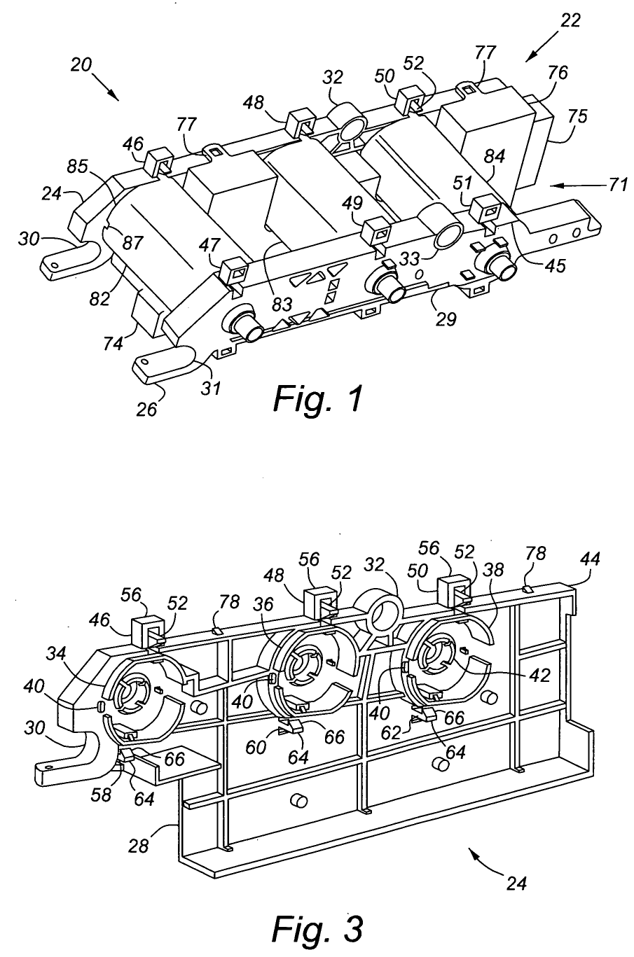

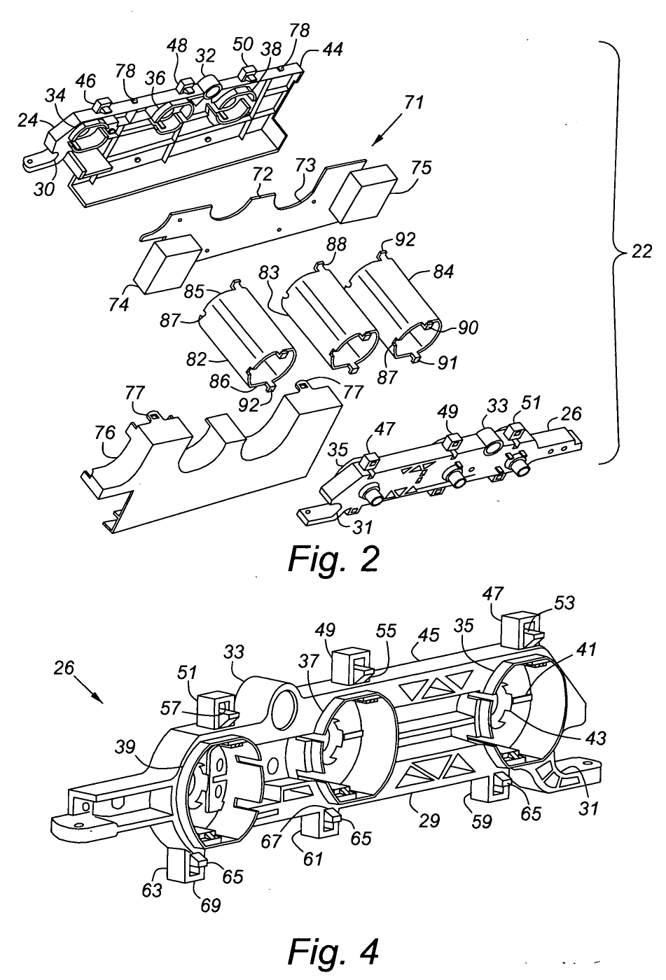

FIGS. 1-5 illustrate a portion of a power adjustable seat system, indicated generally at 20, employed with a vehicle (not shown). A seat motors assembly, indicated generally at 22, forms a part of the seat system 20. Other portions (not shown) of the power adjustable seat system 20 are known to those skilled in the art, and so will not be described in any detail herein.

The seat motors assembly 22 includes a first housing end cap 24 and a second housing end cap 26. The first housing end cap 24 includes a main wall 28 having a first support rod mounting flange 30 and a second support rod mounting flange 32. The first and second support rod mounting flanges 30, 32 are located to receive conventional support rods (not shown) that mount to seat structure in a known manner, and so will not be shown or discussed further herein. Extending from the main wall 28 are a first motor housing mounting wall 34, a second motor housing mounting wall 36, and a third motor housing mounting wall 38. Each motor housing mounting wall 34, 36, 38 includes an alignment tab 40. Also extending from the main wall 28, coaxially located within each motor housing mounting wall 34, 36, 38, are motor mounting flanges 42. The motor mounting flanges 42 each receive an end of one of three motors (not shown). The motors may be, for example, bi-directional motors, which may, for example, operatively engage other portions of the power adjustable seat system 20 to provide horizontal, front vertical, and back vertical drive for a power adjustable seat. The motors and components which they drive will not be shown or discussed further herein as they are known to those skilled in the art.

The first housing end cap 24 also has an upper wall 44 from which a first top snap retention feature 46, a second top snap retention feature 48 and a third top snap retention feature 50 extend. Each top snap retention feature 46, 48, 50 includes a securing flange 52 with a barb 54 extending therefrom, and an overstress preventor 56. The main wall 28 of the first housing end cap 24 includes a first bottom snap retention feature 58, a second bottom snap retention feature 60, and a third bottom snap retention feature 62. Each bottom snap retention feature 58, 60, 62 includes a securing flange 64 with a barb 66 extending therefrom. Although not shown in this embodiment, the bottom snap retention features 58, 60, 62 may also include an overstress preventor.

The second housing end cap 26 includes a main wall 29 having a first support rod mounting flange 31 and a second support rod mounting flange 33. The first and second support rod mounting flanges 31, 33 are located to receive the conventional support rods (not shown). Extending from the main wall 29 are a first motor housing mounting wall 35, a second motor housing mounting wall 37, and a third motor housing mounting wall 39. Each motor housing mounting wall 35, 37, 39 includes an alignment tab 41. Also extending from the main wall 29, coaxially located within each motor housing mounting wall 35, 37, 39, are motor mounting flanges 43. The motor mounting flanges 43 each receive an end of one of the three motors (not shown).

The second housing end cap 26 also has an upper wall 45 from which a first top snap retention feature 47, a second top snap retention feature 49 and a third top snap retention feature 51 extend. Each top snap retention feature 47, 49, 51 includes a securing flange 53 with a barb 55 extending therefrom, and an overstress preventor 57. The main wall 29 of the second housing end cap 26 includes a first bottom snap retention feature 59, a second bottom snap retention feature 61, and a third bottom snap retention feature 63. Each bottom snap retention feature 59, 61, 63 includes a securing flange 65 with a barb 67 extending therefrom, and an overstress preventor 69.

The seat motors assembly 22 may also include a printed circuit board assembly 71 that includes a printed circuit board (PCB) 72, which mounts directly to the first housing end cap 24 with fasteners or by some other means. The PCB 72 may include cut out portions 73 for fitting around motor housing mounting walls 36, 38. The printed circuit board assembly 71 has a first electrical connector 74 and a second electrical connector 75, connected to the PCB 72, for receiving power/signals. The PCB 72 may include, for example, motor control electronics that distribute the power/signals to the motors.

A PCB cover 76 includes cover mounting flanges 77 that snap-fit over corresponding PCB cover mounting tabs 78 on the first housing end cap 24. The PCB cover 76 mounts to the first housing end cap 24 over the PCB 72 in order to protect the PCB 72 from damage while still allowing access to the first and second electrical connectors 74, 75. The PCB cover 76 easily snaps on and off in order to protect the PCB 72 while still allowing for easy access when needed for servicing.

The seat motors assembly 22 also includes a first motor housing 82, a second motor housing 83, and a third motor housing 84. The motor housings 82, 83, 84 are metal and have a thickness needed to provide sufficient electromagnetic interference protection. Each motor housing 82, 83, 84 is sized and shaped to hold and support the desired size of bi-directional motor (not shown), which can be a conventional motor.

Each of the motor housings 82, 83, 84 has a first end 85 that mounts about a respective one of the first, second and third motor housing mounting walls 34, 36, 38. Each of the motor housings 82, 83, 84 also has a second opposed end 86 that mounts about a respective one of the first, second and third motor housing mounting walls 35, 37, 39. The motor housing mounting walls help to support and assure proper location and orientation of the motor housings 82, 83, 84.

An alignment recess 87 on each of the first ends 85 of the motor housings 82, 83, 84 aligns with its respective alignment tab 40 on the first housing end cap 24. Each of the first ends 85 also includes a top snap-in tab 88 and a bottom snap-in tab (not shown, but similar to the top tab). Each of the second ends 86 includes a top snap-in tab 90 and a bottom snap-in tab 91. Each of the snap-in tabs 88, 90, 91 includes a lip 92. The lips 92 interact with the snap retention features in order to secure the motor housings 82, 83, 84 to the housing end caps 24, 26, while still allowing for relatively simple and easy disassembly of the seat motors assembly 22 when required for servicing, as discussed below.

During assembly of the seat motors assembly 22, the PCB 72 is secured to the first housing end cap 24 by fasteners or other means, and the PCB cover 76 is mounted over that and secured by engaging the cover mounting flanges 77 over the cover mounting tabs 78. The motors (not shown) are inserted into the motor housings 82, 83, 84, and the motor housings 82, 83, 84 assembled to the housing end caps 24, 26.

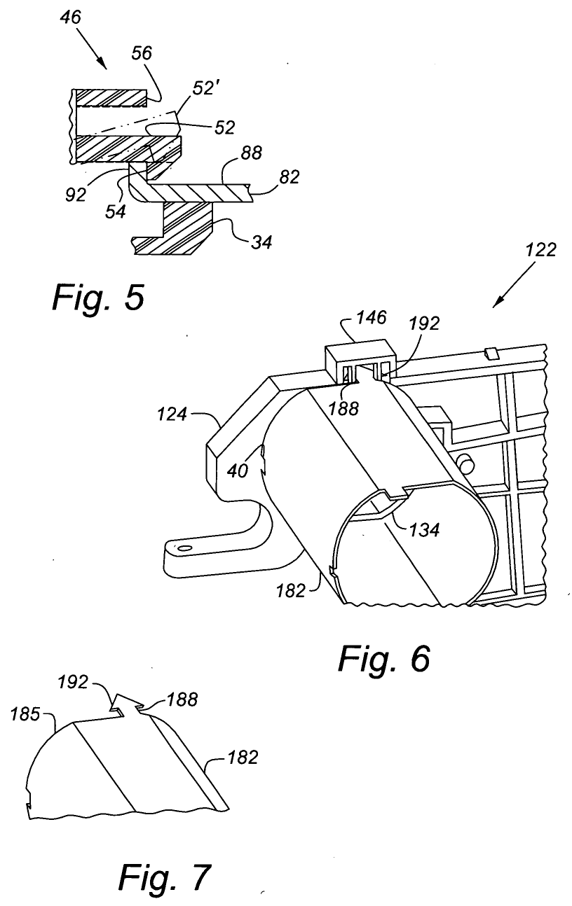

The motor housings 82, 83, 84 are assembled to the housing end caps 24, 26 by aligning each alignment recess 87 with its respective alignment tab 40, 41 and each snap-in tab 88, 90, 91 with its respective snap retention feature 46-51. As the end caps 24, 26 and motor housings 82, 83, 84 come together, each of the first ends 85 of the motor housings 82, 83, 84 will slide over its corresponding motor housing wall 34, 36, 38, and each of the second ends 86 will slide over its corresponding housing wall 35, 37, 39. In addition, while these components are coming together, the lips 92 on the snap-in tabs 88, 90, 91 will cause the corresponding securing flanges 52, 53, 64, 65 to elastically flex until the lips 92 slide past the barbs 54, 55, 66, 67, at which point the snap-in tabs 88, 90, 91 will snap back close to their original positions. The elastic flexing of the securing flange 52 is shown in FIG. 5 in phantom and identified as 52, while the flange 52 after assembly is also shown in FIG. 5.

The term “snap” as used herein is directed to members that elastically flex while two components are being assembled, and when the components are essentially fully assembled, the members will return (i.e., snap) back close to their original positions in order to secure the components together. This is different than members that are plastically deformed (i.e., permanently take a new shape) during assembly, such as, for example, metal flanges on a first component that are bent down over a second component to secure the two together.

The overstress preventors 56, 57, 69 are each located adjacent to a securing flange 52, 53, 64, 65 in the direction of flexing. They are spaced from the flanges 52, 53, 64, 65 a sufficient distance to allow the flanges to flex as needed during assembly but close enough to prevent the flanges from flexing too far should the components be misaligned during the assembly operation. That is, they help to prevent the securing flanges 52, 53, 64, 65 from being flexed beyond the plastic range and permanently deformed since a permanently deformed securing flange might not snap back to secure the components together.

Disassembly for servicing is relatively easy. The securing flanges 52, 53, 64, 65 are flexed until each barb 54, 55, 66, 67 clears its respective lip 92, and the housing end caps 24, 26 are slid away from the motor housings 82, 83, 84. The servicing can be performed, and then the components can be reassembled the same as when they were originally assembled. If access to the PCB 72 only is required, then the PCB cover 76 can be easily removed by disengaging the cover mounting flanges 77 from the cover mounting tabs 78 and sliding the PCB cover 76 out of the assembly.

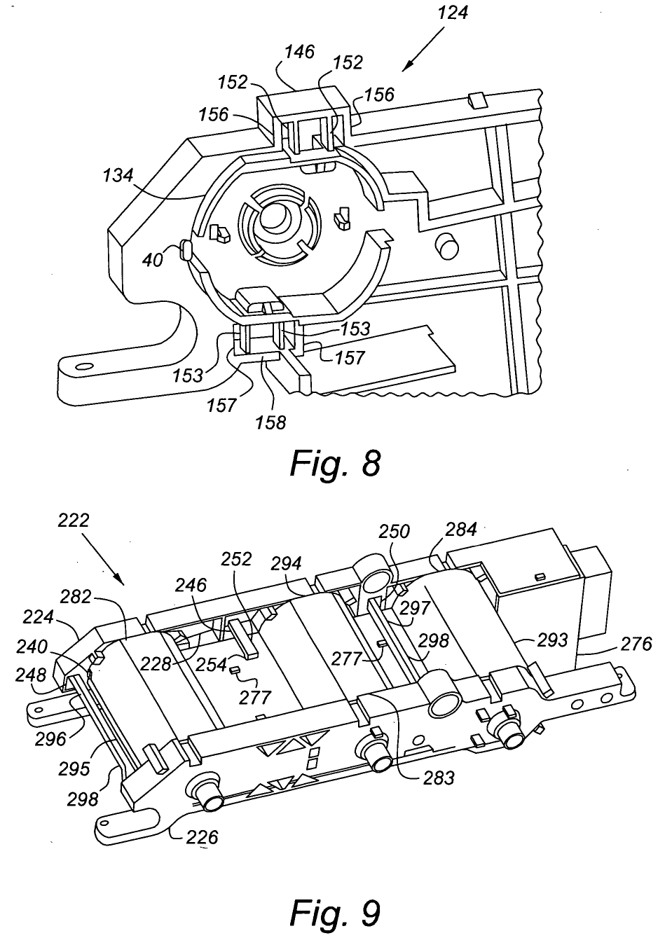

FIGS. 6-8 illustrate a second embodiment of the present invention. Since this embodiment is similar to the first, elements in this embodiment that are the same as elements in the first embodiment will be identified with the same element numbers, while elements that have changed and new elements will be identified with 100-series element numbers.

In this embodiment, the first housing end cap 124 includes the first motor housing mounting wall 134, with an alignment tab 40, and first top and bottom snap retention features 146, 158 in order to align and retain the first motor housing 182. The snap retention features 146, 158 vary significantly from the first embodiment. Each snap retention feature 146, 158 includes a spaced pair of securing flanges 152, 153, with a pair of overstress preventors 156, 157 adjacent to them. The first motor housing 182 has snap-in tabs 188 (only top shown) that include arrowhead shaped lips 192.

Assembly of the seat motors assembly 122 for this embodiment is similar to the first, but with the snap feature differing somewhat. The snap feature as it applies to the top of the first motor housing 182 will be described. During assembly, as the first housing end cap 124 and first motor housing 182 are brought together, the lip 192 (i.e., the arrowhead shaped feature) of the snap-in tab 188 on the first end 185 of the first motor housing 182 presses into the securing flanges 152. As the snap-in tab 188 press in, it will causes the securing flanges 152 to flex outward elastically. The overstress preventors 156 will assure that the securing flanges 152 are not flexed too far should some misalignment occur during assembly. Again, the first end 185 will seat around the first motor housing mounting wall 134 as the snap-in tab 188 passes through the securing flanges 152. The securing flanges 152 will then snap back to essentially their unflexed positions, trapping the lips 192 of the snap-in tabs 188.

While changes to the first top and bottom snap retention features 146, 158 and top snap-in tab 188 are only shown for the first housing end cap 124 and first end 185 of the first motor housing 182, these changes are applicable to the other motor housings and the second housing end cap as well.

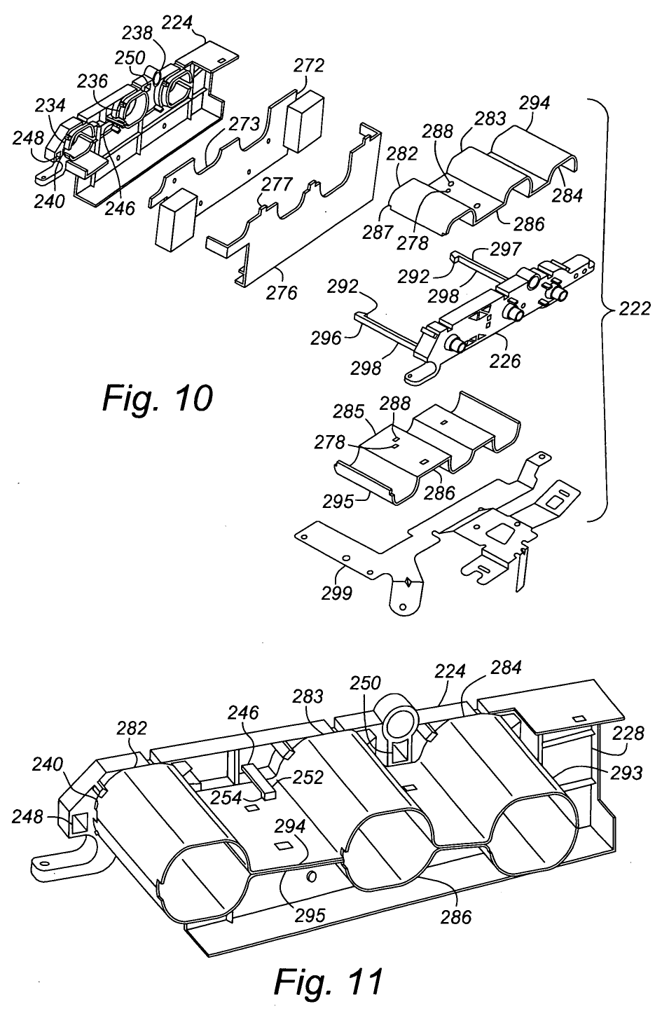

FIGS. 9-11 illustrate a third embodiment of the present invention. Since this embodiment is similar to the first, elements in this embodiment that are the same as elements in the first embodiment will be identified with the same element numbers, while elements that have changed and new elements will be identified with 200-series element numbers. In this embodiment, there is a reduced number of assembly steps since all three motors (not shown) are mounted in a single motor housing.

In this embodiment, the seat motors assembly 222 still includes a first housing end cap 224 and a second housing end cap 226 that sandwich a motor housing 293, but with the motor housing 293 being a single unit formed from an upper motor housing 294 and a lower motor housing 295. The single housing 293 has a first motor housing portion 282, a second motor housing portion 283, and a third motor housing portion 284. The single, integral motor housing 293 for all three motors may provide more support and overall stiffness to the assembly than embodiments with a separate motor housing for each motor.

The first housing end cap 224 includes motor housing mounting walls 234, 236, 238 for receiving and supporting the first end 285 of the motor housing 293. The PCB 272 mounts to the first housing end cap 224 with cutout portions 273 for fitting around the motor housing mounting walls 234, 236, 238. A PCB cover 276 encloses the PCB 272 and includes cover mounting flanges 277 that mate with cover slots 278 in the motor housing 293. The first housing end cap 224 also includes alignment tabs 240 that engage corresponding alignment recesses 287 in the motor housing 293. The first housing end cap 224 has a snap retention feature 246, which includes a securing flange 252 having a barb 254 on its end. The barb 254 engages with a snap-in slot 288 in the motor housing 293 to retain the motor housing 293 against the first housing end cap 224. Two snap retention features 248, 250 are formed in the main wall 228 of the first housing end cap 224 and are positioned for engagement with snap-in tabs on the second housing end cap 226, discussed below.

The second housing end cap 226 includes motor housing mounting walls (not shown in this embodiment) that receive and support the second end 286 of the motor housing 293. First and second snap-in tabs 296, 297 extend from the second housing end cap 226. The snap-in tabs 296, 297 each include a lip 292, which engages with a respective one of the snap retention features 248, 250 of the first housing end cap 226, and an extension arm 298, which extends across the width of the assembly to hold is the assembly together. Of course, the snap retention features and snap-in tabs can be switched between the first and second housing end caps, if so desired.

The seat motors assembly 222 may also include a support bracket 299 mounted under assembly that provides additional mounting support for this assembly.

The assembly of the components for the seat motors assembly 222 of the third embodiment is similar to the first two, with elastic deformation of snap-type features during the assembly process that engage to secure the assembly together. And, of course, the snap retention features and snap-in tabs of the first two embodiments may be employed with this third embodiment in addition to or in place of the retention features shown in the third embodiment, and vice versa.

While certain embodiments of the present invention have been described in detail, those familiar with the art to which this invention relates will recognize various alternative designs and embodiments for practicing the invention as defined by the following claims.

What is claimed is:

1. A seat motors assembly for use in a seat drive mechanism of a vehicle comprising:
a first motor housing having a first end with a first snap-in tab extending therefrom;
a second motor housing having a first end with a first snap-in tab extending therefrom; and
a first housing end cap including a first motor housing mounting wall operatively engaging the first end of the first motor housing and a first snap retention feature engaging with the first snap-in tab of the first motor housing to releasably secure the first motor housing to the first housing end cap, and the first housing end cap including a second motor housing mounting wall operatively engaging the first end of the second motor housing and a second snap retention feature engaging with the first snap-in tab of the second motor housing to releasably secure the second motor housing to the first housing end cap.

2. The seat motors assembly of claim 1 wherein the first motor housing includes a second end, opposed to the first end of the first motor housing, having a second snap-in tab extending therefrom, and the second motor housing includes a second end, opposed to the first end of the second motor housing, having a second snap-in tab extending therefrom, and the seat motors assembly further includes a second housing end cap having a first motor housing mounting wall operatively engaging the second end of the first motor housing and a first snap retention feature engaging with the second snap-in tab of the first motor housing to releasably secure the first motor housing to the second housing end cap, and the second housing end cap having a second motor housing mounting wall operatively engaging the second end of the second motor housing and a second snap retention feature engaging with the second snap-in tab of the second motor housing to releasably secure the second motor housing to the second housing end cap.

3. The seat motors assembly of claim 2 further including a third motor housing releasably secured between the first housing end cap and the second housing end cap.

4. The seat motors assembly of claim 1 wherein the first snap retention feature includes an outwardly extending securing flange having a barb thereon, and the first snap-in tab of the first motor housing has a lip that releasably engages the barb.

5. The seat motors assembly of claim 4 wherein the first snap retention feature includes an overstress preventor located adjacent to the securing flange such that the overstress preventor limits the movement of the securing flange.

6. The seat motors assembly of claim 1 wherein the first motor housing has a second snap-in tab, the second motor housing has a second snap-in tab, and the first housing end cap has a third snap retention feature and a fourth snap retention feature, with the third snap retention feature engaging with the second snap-in tab of the first motor housing to releasably secure the first motor housing to the first housing end cap, and the fourth snap retention feature engaging with the second snap-in tab of the second motor housing to releasably secure the second motor housing to the first housing end cap.

7. The seat motors assembly of claim 6 further including a third motor housing releasably secured to the first housing end cap.

8. The seat motors assembly of claim 6 wherein the first motor housing includes a second end, opposed to the first end of the first motor housing, having a third snap-in tab extending therefrom, and the second motor housing includes a second end, opposed to the first end of the second motor housing, having a third snap-in tab extending therefrom, and the seat motors assembly further includes a second housing end cap having a first snap retention feature engaging with the third snap-in tab of the first motor housing to releasably secure the first motor housing to the second housing end cap, and the second housing end cap having a second snap retention feature engaging with the third snap-in tab of the second motor housing to releasably secure the second motor housing to the second housing end cap.

9. The seat motors assembly of claim 1 wherein the first snap retention feature has spaced parallel securing flanges and the first snap-in tab of the first motor housing has an arrowhead shaped lip that releasably engages the spaced parallel securing flanges.

10. A seat motors assembly for use in a seat drive mechanism of a vehicle comprising:
a motor housing having a first motor portion adapted for receiving a first motor and a second motor portion adapted for receiving a second motor, and a first end and an opposed second end;
a first housing end cap mounted to the first end of the motor housing;
a second housing end cap mounted to the second end of the motor housing;
a first snap retention feature included in one of the first housing end cap and the second housing end cap; and
a first snap-in tab extending from the other of the first housing end cap and the second housing end cap and operatively engaging the first snap retention feature to releasably secure the first housing end cap to the second housing end cap.

11. The seat motors assembly of claim 10 further including a second snap retention feature included in one of the first housing end cap and the second housing end cap, and a second snap-in tab extending from the other of the first housing end cap and the second housing end cap and operatively engaging the second snap retention feature to releasably secure the first housing end cap to the second housing end cap.

12. The seat motors assembly of claim 10 wherein the motor housing has a third motor portion adapted for receiving a third motor.

13. The seat motors assembly of claim 10 further including a second snap retention feature on one of the first housing end cap and the motor housing and a second snap-in tab on the other of the first housing end cap and the motor housing.

14. The seat motors assembly of claim 10 wherein the first housing end cap includes a first motor housing mounting wall operatively engaging the first end of the motor housing at the first motor portion, and a second motor housing mounting wall operatively engaging the first end of the motor housing at the second motor portion.

15. A seat motors assembly for use in a seat drive mechanism of a vehicle comprising:
a motor housing having a first end and an opposed second end;
a first housing end cap mounted to the first end of the motor housing;
a second housing end cap mounted to the second end of the motor housing;
a first snap retention feature on one of the first housing end cap and the motor housing; and
a first snap-in tab on the other of the first housing end cap and the motor housing and operatively engaging the first snap retention feature to releasably secure the first housing end cap to the motor housing.

16. The seat motors assembly of claim 15 including a second motor housing having a first end, mounted to the first housing end cap, and an opposed second end, mounted to the second housing end cap, with the motor housing adapted to receive a first motor and the second motor housing adapted to receive a second motor, and the second ends of the motor housing and the second motor housing each including a second snap-in tab, and the second housing end cap including a pair of second snap retention features, with each of the second snap retention features engaging a respective one of the second snap-in tabs to releasably secure the second housing end cap to the motor housing and the second motor housing.

17. The seat motors assembly of claim 16 wherein the first ends of the motor housing and the second motor housing each include a third snap-in tab, and the first housing end cap includes a pair of third snap retention features, with each of the third snap retention features engaging a respective one of the third snap-in tabs to releasably secure the first housing end cap to the motor housing and the second motor housing.

18. The seat motors assembly of claim 15 wherein the motor housing includes a first motor portion adapted to receive a first motor and a second motor portion adapted to receive a second motor, and the seat motors assembly further includes a second snap retention feature on one of the first housing end cap and the second housing end cap, and a second snap-in tab extending from the other of the first housing end cap and the second housing end cap and operatively engaging the second snap retention feature to releasably secure the first housing end cap to the second housing end cap.

19. The seat motors assembly of claim 18 further including a third snap retention feature on one of the first housing end cap and the second housing end cap, and a third snap-in tab extending from the other of the first housing end cap and the second housing end cap and operatively engaging the third snap retention feature to releasably secure the first housing end cap to the second housing end cap.

20. The seat motors assembly of claim 15 wherein the first housing end cap includes a cover mounting tab and the seat motors assembly further includes a printed circuit board mounted to the first housing end cap and a PCB cover located adjacent to the printed circuit board and including a cover mounting flange that engages the cover mounting tab for releasably securing the PCB cover to the first housing end cap.
